(19) United States
(12) Patent Application Publication
(10) Pub. No.: US 2003/0061061 A1
(43) Pub. Date: Mar. 27, 2003

(54) Uniform data model

(76) Inventors: Earl D. Cox, Chapel Hill, NC (US); Franco R. Negri, Columbia, MD (US)

Correspondence Address: Larson & Associates, P.C., 221 East Church Street, Frederick, MD, 21701-5405, US

(21) Appl. No.: 10/032,968

(22) Filed: Oct. 26, 2001

Related U.S. Application Data
(60) Provisional application No. 60/243,397, filed on Oct. 27, 2000.

(51) Int. Cl. G06F 17/60

(52) U.S. Cl. 705/1

(57) ABSTRACT

A uniform data model for an event is described. The model consists of multiple categories, each of which includes multiple measures with each of the measures represented by either a quantitative or qualitative value. In constructing an event representation in accordance with the uniform data model, a category, to which the event belongs, is determined first. One or more measurement type, based on which the event is triggered, is then specified. The values of the selected measurements, either quantitative or qualitative, are then incorporated into the uniform data representation for the event.

### APPLICATION DATA

Four utility patent applications are being filed simultaneously. The subject matter of each is incorporated into the others by reference thereto. They are entitled “The eService Business Model”, “Framework for eService Management”, “Behavior Experts in eService Management”, and “The Uniform Data Model”.

The instant utility patent application claims the benefit of the filing date of Oct. 27, 2000 of earlier pending provisional application No. 60/243,397 under 35 U.S.C. 119(e).

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

1. Field of the Invention

Aspects of the present invention relate to the field of e-commerce. Other aspects of the present invention relate to a method to develop a uniform data interface to facilitate the communication among different applications.

2. General Background and Related Art

The expanding use of the World-Wide Web (WWW) for business continues to accelerate and virtual corporations are becoming more commonplace. Many new businesses, born in this Internet Age, do not employ traditional concepts of physical site location (bricks and mortar), on-hand inventories and direct customer contact. Many traditional businesses, who want to survive the Internet revolution are rapidly reorganizing (or re-inventing) themselves into web-centric enterprises. In today's high-speed Business-to-Business (B2B) and Business-to-Customer (B2C) eBusiness environment, a corporation must provide high quality service, scale to accommodate exploding demand and be flexible enough to rapidly respond to market changes.

The growth of eBusiness is being driven by fundamental economic changes. Firms that harness the Internet as the backbone of their business are enjoying tremendous market share gains—mostly at the expense of the unenlightened that remain true to yesterday's business models. Whether it is rapid expansion into new markets, driving down cost structures, or beating competitors to market, there are fundamental advantages to eBusiness that cannot be replicated in the “brick and mortar” world.

This fundamental economic shift, driven by the tremendous opportunity to capture new markets and expand existing market share, is not without great risks. If a customer cannot buy goods and services quickly, cleanly, and confidently from one supplier, a simple search will divulge a host of other companies providing the same goods and services. Competition is always a click away. eBusinesses are rapidly stretching their enterprises across the globe, connecting new products to new marketplaces and new ways of doing business. These emerging eMarketplaces fuse suppliers, partners and consumers as well as infrastructure and application outsourcers into a powerful but often intangible Virtual Enterprise. The infrastructure supporting the new breed of virtual corporations has become exponentially more complex—and, in ways unforeseen just a short while ago, unmanageable by even the most advanced of today's tools. The dynamic and shifting nature of complex business relationships and dependencies is not only particularly difficult to understand (and, hence manage) but even a partial outage among just a handful of dependencies can be catastrophic to an eBusiness' survival.

Businesses are racing to deploy Internet enabled services in order to gain competitive advantage and realize the many benefits of eBusiness. For an eBusiness, time-to-value is so critical that often these business services are brought on-line without the ability to manage or sustain the service. eBusinesses have been ravaged with catastrophe after catastrophe. Adequate technology, to effectively prevent these catastrophes, does not exist.

eBusiness infrastructures operate around the clock, around the globe, and constantly evolving. If a critical supplier in Asia cannot process an electronic order due to infrastructure problems, the entire supply chain comes to a grinding halt. Who understands the relationships between technology and business processes and between producer and supplier? Are they available 24×7×365? How long will it take to find the right person and rectify the problem? The promise of B2B, B2C and eCommerce in general will not be fully realized until technology is viewed in light of business process to solve these problems.

Web-enabled eBusiness processes effectively distill all computing resources down to a single customer-visible service (or eService). For example, a user interacts with a web site to make an on-line purchase. All of the back-end hardware and software components supporting this service are hidden, so the user's perception of the entire organization is based on this single point of interaction. How can organizations mitigate these risks and gain the benefits of well-managed eServices?

Never before has an organization been so dependent on a single point of service delivery—the eService. An organization's reputation and brand depend on the quality of eService delivery because, to the outside world, the eService is the organization. If service delivery is unreliable, the organization is perceived as unreliable. If the eService is slow or unresponsive, the company is perceived as being slow or unresponsive. If the Service is down, the organization might as well be out of business.

Further complicating matters, more and more corporations are outsourcing all or part of their web-based business portals. While reducing capital and personnel costs and increasing scalability and flexibility, this makes Application Service Providers (ASPs), Internet Service Providers (ISPs) and Managed Service Providers (MSPs) the custodians of a corporation's business. These “xSPs” face similar challenges—delivering quality service in a rapid, cost efficient manner with the added complication of doing so across a broad array of clients. Their ability to meet Service Level Agreements (SLAs) is crucial to the eBusiness developing a respected, high quality electronic brand—the equivalent of prime storefront property in a traditional brick and mortar business.

The Internet enables companies to outsource those areas in which the company does not specialize. This collaboration strategy creates a loss of control over infrastructure and business processes between companies comprising the complete value chain. Partners, including suppliers and service providers must work in concert to provide a high quality service. But how does a company control infrastructure which it doesn't own and processes that transcend its' organizational boundaries? Even infrastructure outsourcers don't have mature tools or the capability to manage across organizational boundaries.

The underlying problem is not lack of resources, but the misguided attempt to apply yesterday's management technology to today's eService problem. As noted by Forrester Research, “Most companies use 'systems' management tools to solve pressing operational problems. None of these tools can directly map a system or service failure to business impact.” To compensate, they rely on slow, manual deployment by expensive and hard-to-find technical personnel to diagnose the impact of infrastructure failures on service delivery (or, conversely, to explain service failures in terms of events in the underlying infrastructure). The result is very long time-to-value and an unresponsive support infrastructure. In an extremely competitive marketplace, the resulting service degradation and excessive costs can be fatal.

### BRIEF DESCRIPTION OF THE DRAWINGS

The present invention is further described in the detailed description which follows, by reference to the noted drawings by way of non-limiting exemplary embodiments, in which like reference numerals represent similar parts throughout the several views of the drawings, and wherein:

FIG. 1 shows the BeX Input-Output Model;

FIG. 2 shows the processing architecture of a behavior expert;

FIG. 3 shows Behavior Experts Coupled Through the UDM and illustrates how UDM is used for interfacing different BeXs;

FIG. 4 shows The BeX Uniform Data Model Relationships;

FIG. 5 shows event sharing among BeXs using UDM;

FIG. 6 shows The Quantitative and Qualitative UDM;

FIG. 7 shows Event Flow Through the eService System;

FIG. 8. shows the flow of events in the topology; and

FIG. 9 shows the relationships among evidence events, status events and BeXs.

### DETAILED DESCRIPTION

In the framework of an eService management system, Behavior eXperts (BeXs) act on observation data from different sources of infrastructure components, collaorate with other behavior experts, and ensure the quality of the eService. To facilitate the communication among BeXs, a method and system is described below for a uniform data model that addresses the need for a standard interface to be used by BeXs to interact in a heterogenous environment.

The Uniform Data Model (UDM) is the glue that connects and binds all the Behavior Experts (BeX's) in an eService management system. Employing a consistent and well-structured representation of performance metrics that includes qualitative (ordinal ranking of the performance relative to a scale of possible performance measures) and quantitative (absolute measures expressed as a numeric, interval, percentage, or ratio value) measures, the UDM organizes information in terms of fundamental categories and intrinsic measures within these categories. This information centric approach, coupled with a template architecture in the design of Behavior Experts, allows a simple yet dynamic line of attack to infrastructure and business process modeling.

There are two distinct and complementary intelligent agents in an eService Management (eSM) environment—the component Behavior eXpert (cBeX) and the integrator Behavior eXpert (iBeX). The difference between a cBeX and an iBeX, however, is only functional instead of capability and power. Both types of BeXs have exactly the architecture.

The Uniform Data Model is designed to insulate the internal processes of a BeX from the outside world (in much the same way that object oriented design insulates the client from knowledge about the internal workings of an Object). A BeX assesses the state of other BeXs in an eService management system through the use of the UDM.

The BeX concept provides a coherent and consistent method of analyzing processes, services, applications, and other abstract concepts in the rapid changing Internet business environment. These “agents”, patterned after the cellular automata model, provide distributed intelligence to support eService management services and functions. It is the BeX concept that connects the model of eService management with the actual implementation of the management. A BeX may have one or more parents as well as one or more children. A BeX receives events from its children and sends events to its parents.

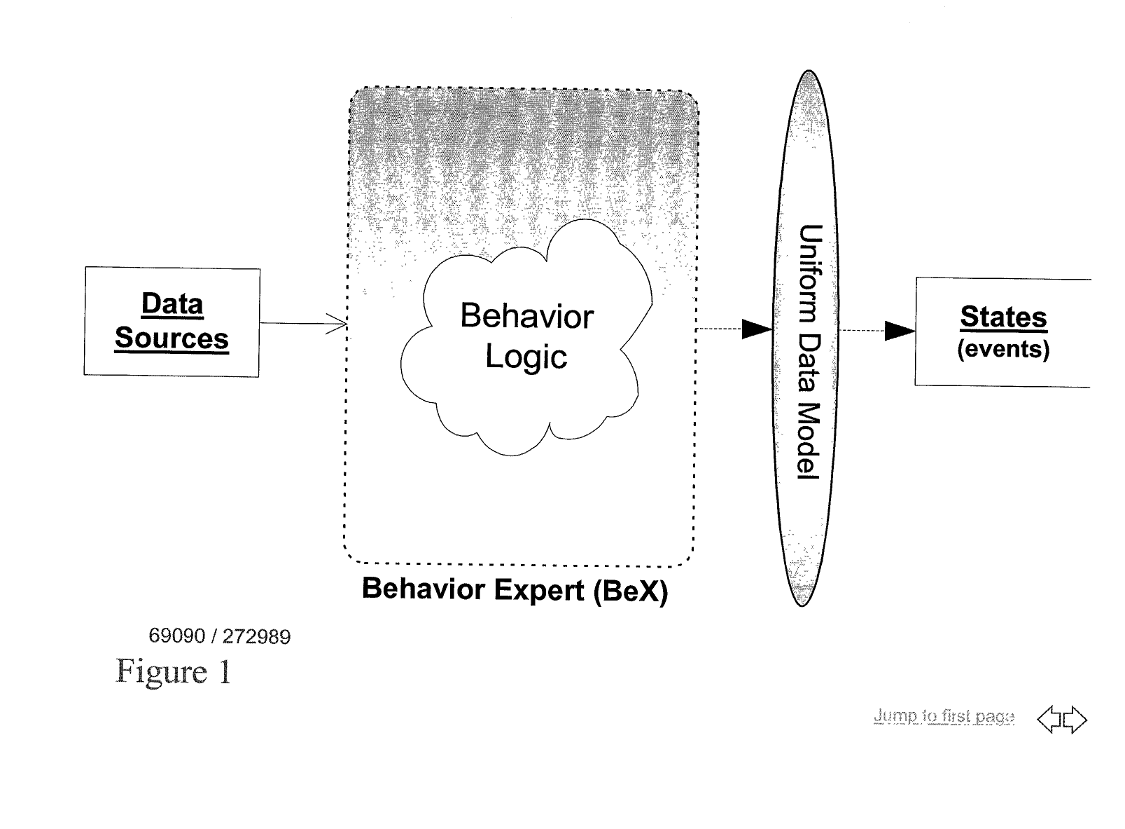

These events are messages about the state of a process or a component. BeXs communicate through events in a uniform way throughout an eService management system. An event is thrown (or issued) by a rule in a BeX's internal logic. Rules define actual or potential problems in the performance of the process, component, or service associated with the BeX. When a rule's monitoring condition is true (a problem has occurred or likely to occur), it throws an event describing the problem. These events are encoded with a uniform structure and content, enforced by the Uniform Data Model protocol. The relationship between the UDM and a BeX is shown in FIG. 1.

Fundamentally, the Uniform Data Model (UDM) defines the organization of an event thrown by a rule in BeX logic. The UDM structures the visible states of a BeX into a well-defined and narrow set of values. A BeX can tell the outside world that it has a change in state related to a specific category such as transactions, the network, an application, or the operating system. Within each category, an event may be characterized as a measure related to availability, throughput, or response time These basic measures are often referred to as ART (Avaliability, Response time, and Throughput).

There may be an additional category, called General, and a fourth measure, called readiness. They are purely qualitative assessments of the composite performance of a service or a process. These form an integral part of the UDM but in general ART events are used to compute the current state of topologically dependent nodes.

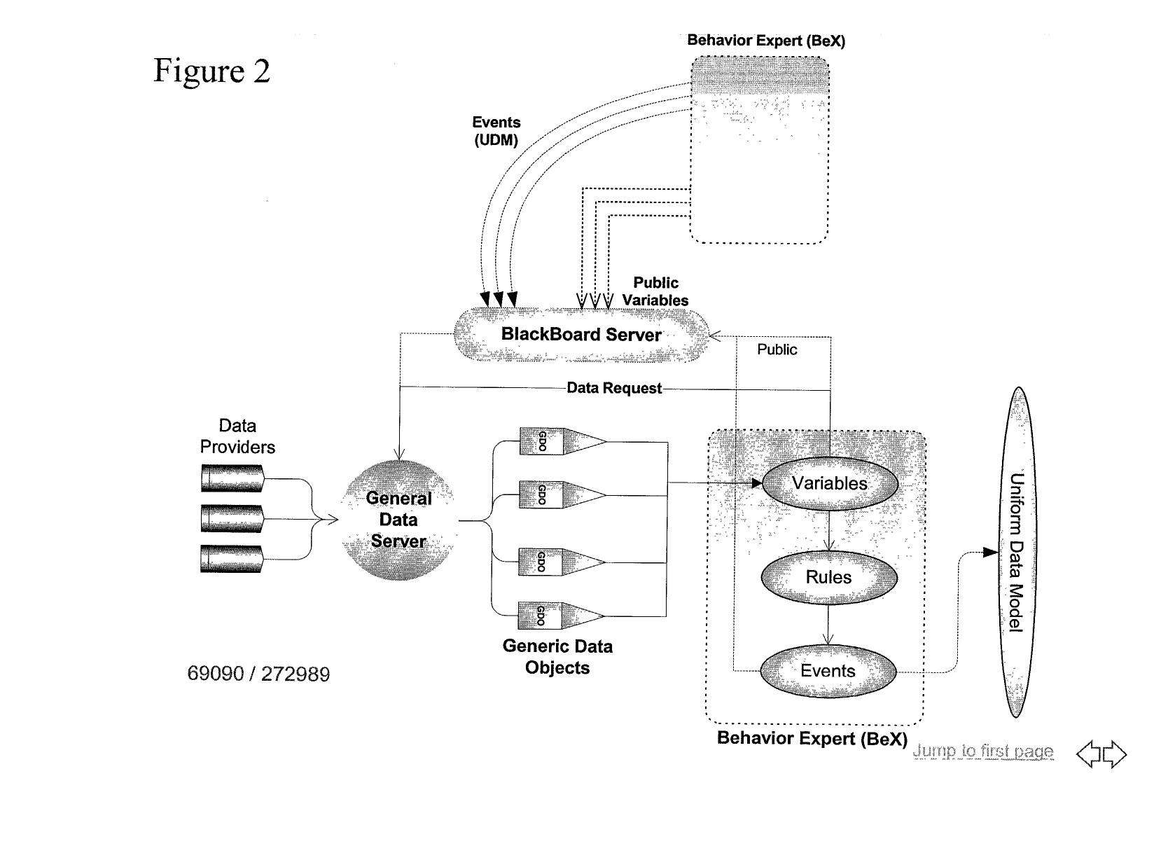

A BeX is not physically attached to or compiled with a component or application, but works symbiotically—that is, it collects operational information from the operating system, from application API calls, from audit log files, from transaction statistics, from the network, and from other Behavior Experts. These are fused together through a collection of rules to estimate the current performance state of the process. This state—basically its operability—is expressed to the outside world through a series of events. The events organize this operability in terms of a fixed number of categories and, within category, in terms of fixed number of measurements. FIG. 2 illustrates how BeXs interact with each other.

In FIG. 2, a BeX reads a variety of data sources (including the public variables and events from other Behavior Experts available through the Blackboard Server). All BeXs are coupled to a General data Server (GDS) that transparently manages the acquisition of observation data from a diverse spectrum of sources:

Conventional data providers—programs based primarily on the application program interfaces (API's) associated with conventional infrastructure processes (web servers, databases, application servers, etc) as well as specialized API's exposed as part of client applications (the “things” that actually run on an application server, as an example).

Log file adapters—returns the results of applying regular expression and pattern matching analysis to an application's audit or log file.

Operating system and system resources—statistics and point measurements about the availability, consumption, use, and nature of system resources (CPU utilization, disk space availability, virtual storage swap file size, etc).

External and Internal Transactions—statistics associated with synthetic transactions. Transaction based data indicates whether or not a service is actually on-line and responding (in an acceptable time interval) to customer requests.

Network Traffic—information about the availability and performance of the network including statistics about coonnectiopns, transfer rates, acknowledgements, etc.

GDS makes the observation data available, in the form of Generic Data Objects, to BeXs. Using the observation data, a BeX populates a set of variables, runs a collection of analysis rules, and throws an event when a rule is fired. These events are instantiated elements in the Uniform Data Model and are posted on a blackboard server. The blackboard is visible to all BeXs and any event posted on the blackboard can be accessed by any BeX. By standardizing the event interface using the UDM, it facilitates efficient communication among BeXs.

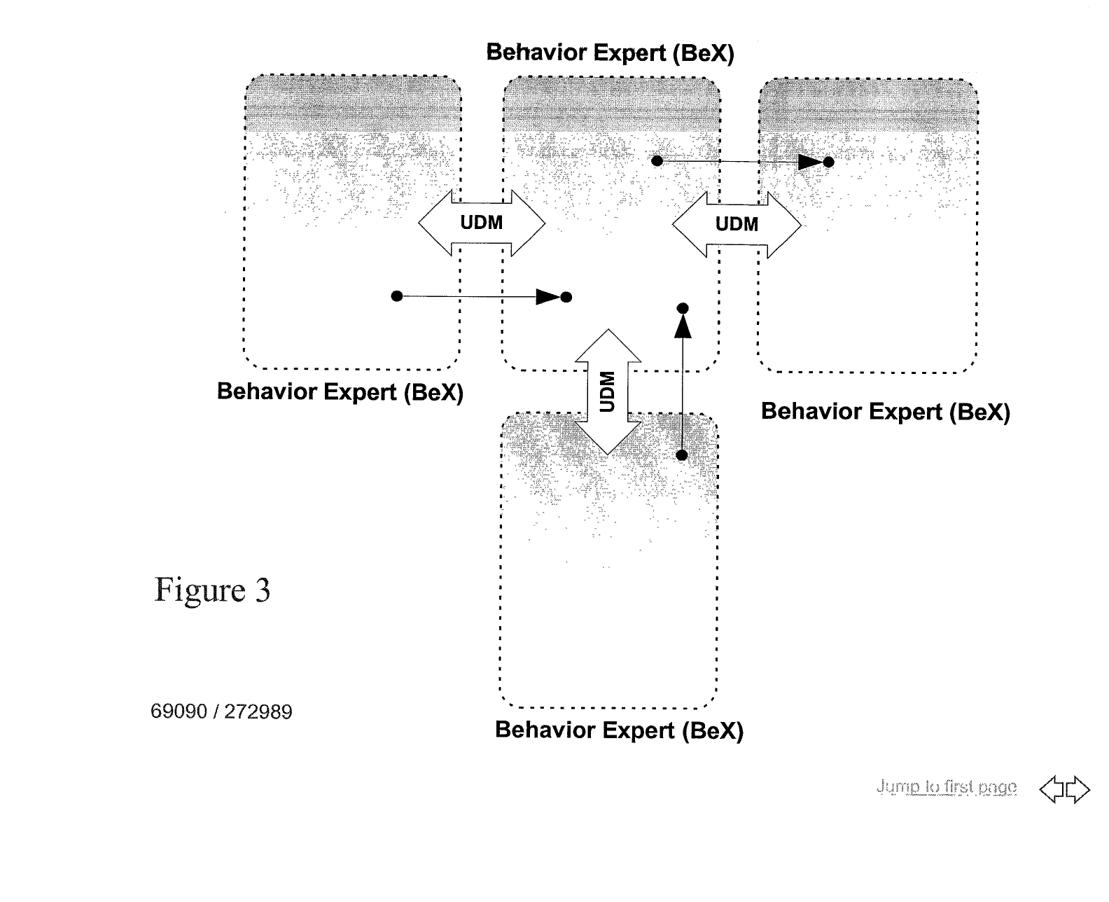

FIG. 3 illustrates how UDM is used for interfacing different BeXs. It is the exchange of events among BeXs that couples BeXs together with a flexible topology.

The UDM is responsible for standardization of information exposed by a BeX. It is not, however, a vehicle for the propagation of status (or states) through the system. This propagation rests solely on the logic of BeXs. A propagated state is a decision or forecast made by a higher level BeX when it receives information about the behavior of its dependencies. However, in most instances, the logical rules in a parent BeX—measuring its actual real-time performance—will determine whether its state should change (and thus be reflected in the eService management model).

UDM Characteristics

The Uniform Data Model describes the quantitative and qualitative operability of a service, process, or component.

The UDM has two consistent dimensions: categories and measures. Each category is divided into a set of measures. Each (category,measure) has a qualitative and a quantitative property.

The UDM provides a coherent, systematic, and uniform interface for BeXs that monitor all families of an infrastructure (such as web servers, databases, application servers, etc).

Elements (or individual occurrences) of a family use element-specific data sources. This means that the input to a BeX (from the data providers) is not directly described by the UDM.

Entity families have the same (inter-changeable) published interface. This means that each family of entities—operating systems, web servers, databases, etc.—have exactly the same set of published attributes.

The public interface of any BeX is limited to a finite set of abstract groups whose values are drawn from a finite set of domains. This means that BeX to BeX communication is limited to a rather small number of things.

The published set of base properties in the interface is never optional. Each BeX must expose each of the Base Categories and Base Measures. It does not mean that a BeX throws a full range of (category,measure) events each time it throws any event. It means that the rules (the knowledge logic of a BeX) must, taken as a whole, throw events that define the full range of measures.

The core UDM specification is BeX independent. This means that the published (exposed) UDM for a cBeX is exactly the same as the UDM for an iBeX. This is a natural consequence of the underlying nature of the BeX—that a cBeX and an iBeX are actually functional forms of the same BeX object.

The UDM is both BeX extensible and client extensible. This means that a BeX can use a super-set of the core UDM (the iBeX does this when it uses the General category and Readiness measurement—see discussion in this document). A client can add category, measure, and specificity values. These extensions are, however, always optional.

What does the Uniform Data Model mean? The UDM defines a uniform, published interface for each family of objects or entities in an eService management environment. There is a single UDM specification for all types of BeXs. This means, events thrown by different BeXs (e.g., an event thrown by a cBeX associated with an Linux Operafing System or an event thrown by a cBeX associated with an NT Operating system) will have the same external interface. The same holds true for each sub-family of applications—databases, web servers, load balancers, and so forth. These families (all web servers or all databases) thus become interchangeable elements in the client model.

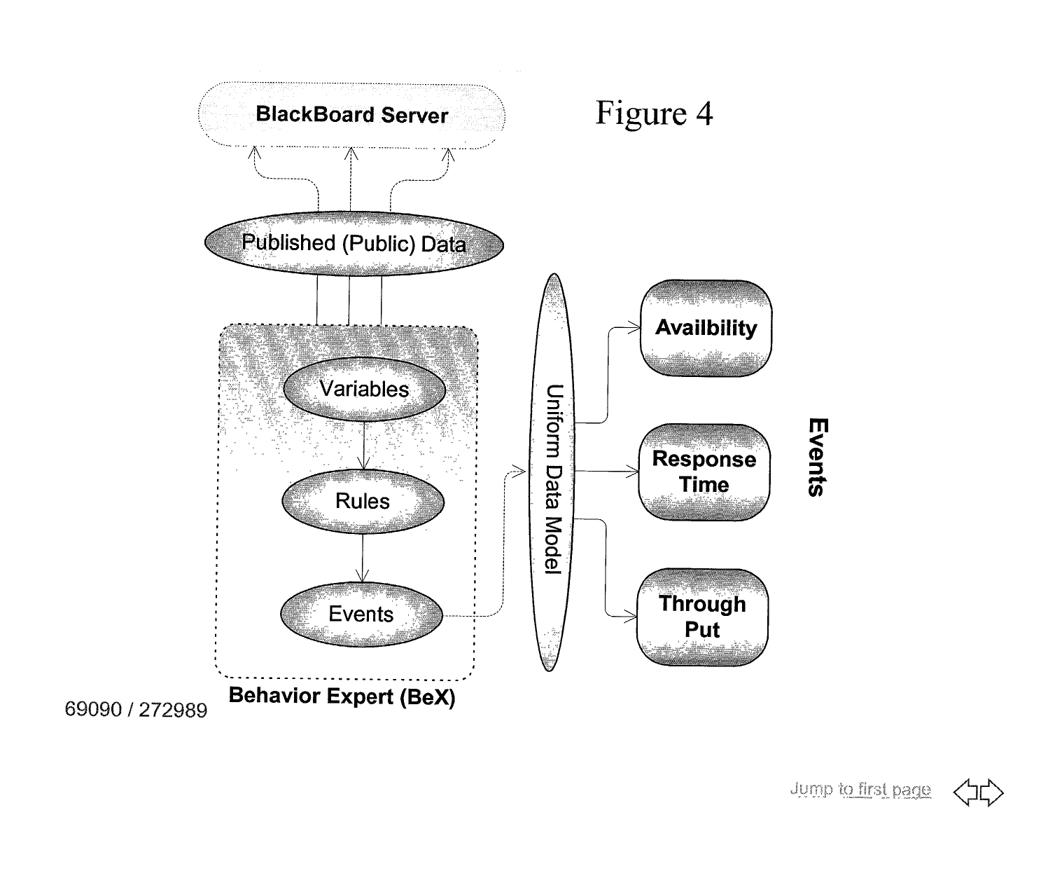

The uniform data model specifies the event interface between all BeXs. It does not specify, however, the contents of the public data elements exposed by a BeX. FIG. 4 shows the UDM organization for a typical BeX and the structure of its event.

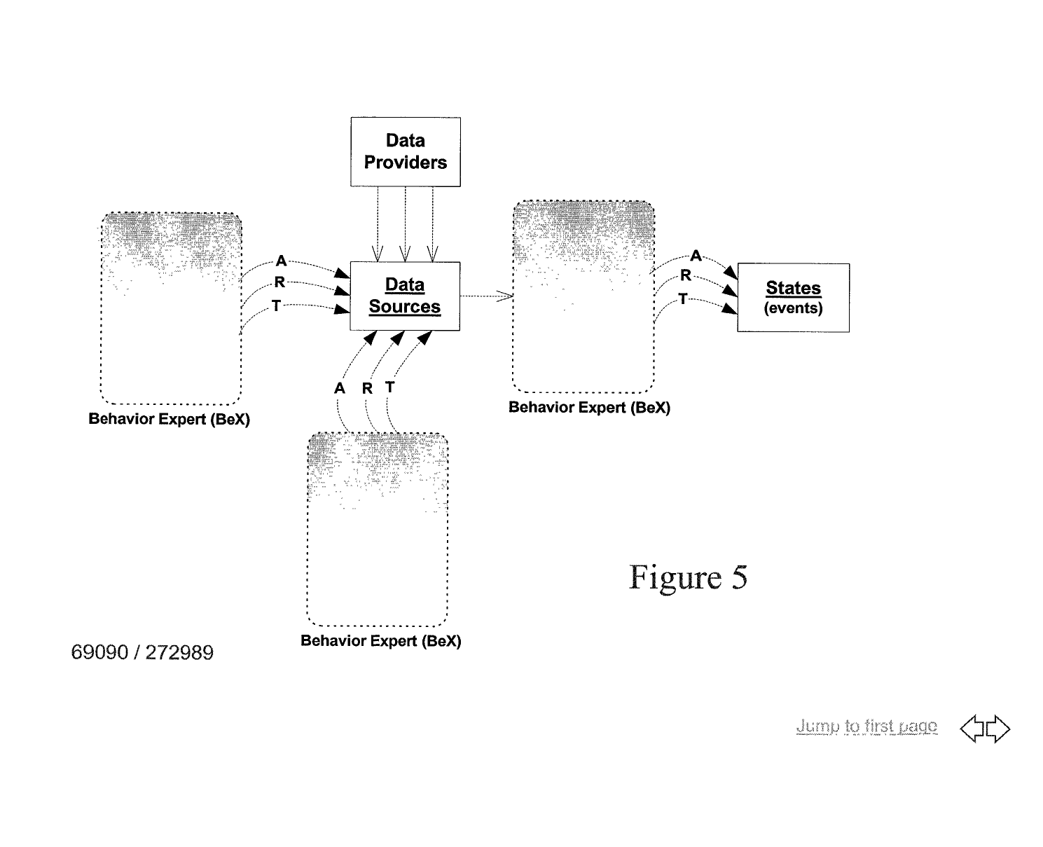

A BeX can publish any number of variables with their own properties and characteristics; however, all the external events must conform to the Uniform Data Model. This means that a BeX cannot issue an event that is not part of the UDM protocol. This approach insures complete interoperability between BeXs (a complete discussion on BeXs is disclosed in provisional patent application “. . . ”, application no . . . ). FIG. 5 illustrates how the UDM event model provides a uniform coupling between BeXs and thus provides a consistent method of communication and plug-and-play interoperability.

FIG. 5 illustrates event sharing among BeXs using UDM. Why a uniform data model is important? The UDM has several important objectives: (1) a reduction in complexity, (2) a focus on root cause analysis in terms of general problems areas instead of devices, (3) a consistent and predictable spectrum of data that can be used to easily create integration BeX modules in a “plug and play” environment, (4) a clear and concise method of propagating status through the model topology, (5) a precise definition of the analytical requirements for each BeX type, and (6) a way of displaying information that is consistent with the operational perspectives of the xSP technical management.

How is the UDM organized? The Uniform Data Model is organized around a published interface that exposes a set of base categories and, within each base category, a set of base measures. There are six Categories and four Measures. Five of the Categories pertain to all BeX modules. Three of the Measures pertain to all BeX modules. The first Category GENERAL and the fourth Measure, Service Readiness, are used primarily by the highest-level iBeX's and are optional. These categories and measures are an intrinsic part of the eService management architecture. As the following table illustrates, the category and measures form a related matrix.

TABLE 1
The Uniform Data Model Dimensions

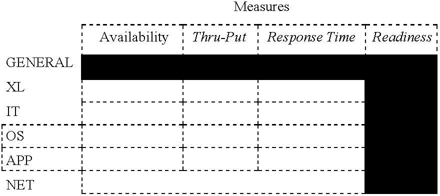

Categories

Categories define the principle organization of information in the system and distribute knowledge through broad segments of important categories. Each category represents a critical barometer in the support of both the system infrastructure as well as the over-all business model.

GENERAL A Meta-category. The General category is used by high level iBeX or service level behavior experts to report their over-all status without a partition into one of the principal categories.

XT External Transactions. Properties associated with the behavior of the external world (such as the transaction characteristics across the internet or across an intranet). External transactions often define the customer perspective on the robustness or readiness of the service element (or component).

IT Internal Transaction. Properties associated with transactions initiated within the infrastructure itself (such as transactions coming into the system through the web server or the application server.) Internal transactions provide an insight into the performance characteristics of the components comprising a specific infrastructure or business model.

OS Operating System. Properties associated with the underlying operating system. These properties deal centrally with the availability and utilization of resources. Operating system attributes include such diverse indicators as available CPU time, disk space utilization, virtual memory paging rates, etc.

APP Applications. Properties associated with software systems running in the business and infrastructure space. Application properties involve a wide spectrum of services ranging from the actual behavior of web servers and application servers themselves to the executing applications to the behavior of CGI scripts and HTTP operations that support and connect the complete business service.

NET Network. Properties associated with networks—depending on the level—include packages in, out, discards, failures, connections, bytes, etc. These properties define the network traffic, its operational state (effectiveness), and the ability of transactions to travel through the system.

Measures

Measures indicate a specific type of serviceability within the category. The granularity of the Measure is the fundamental instrumentation in the Uniform Data Model—all categories emit events that define one or more measures in the same range of values—Availability, Response Time, Throughput, and (for an iBeX) Service Readiness. Measure values consist of a quantitative as well as a qualitative measure. It is primarily the qualitative measure that is used by the iBeX information management network to compute the over-all performance basis of a service and its infrastructure.

| Measure | Quantitative | Qualitative |
|---|---|---|
| Availability | A numeric value defining | A qualitative assessment of |
| | the actual availability of | the category availability. In a |
| | the system over some | strictly Boolean approach this |
| | measure (such as the | is, of course, either one [1] or |
| | average availability over | zero [0]. However, as a time- |
| | the past one hundred | varying or fuzzy assessment, |
| | sample periods). | we can view availability as a |
| | | degree to which the facility is |
| | | failing (or is coming back on |
| | | line). |
| Response | A numeric value defining | A qualitative assessment (or |
| Time | the actual response time of | measure) of the category |
| | the system over some | response time. This is the |
| | measure (such as the | degree to which the response |
| | average response time over | time is considered good or |
| | the past one hundred | bad on a psychometric scale |
| | sample periods). | in the bounded interval |
| | | [0, 10]. |
| Through- | A numeric value defining | A qualitative assessment (or |
| Put | the actual throughput of | measure) of the category |
| | the system over some | throughput. This is the degree |
| | measure (such as the | to which the throughput is |
| | average throughput over | considered good or bad on a |
| | the past one hundred | psychometric scale in the |
| | sample periods). | bounded interval [0, 10]. |
| Readiness | 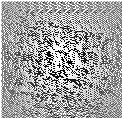 | A qualitative assessment (or measure) of the general component, process, or service readiness. This is the degree to which the readiness is considered good or bad on a psychometric scale in the bounded interval [0, 10]. |

In the cBeX UDM, we are often concerned with the OS and APP categories and their measures (indicated by the dashed regions in Table 1). On the other hand, integration BeXs can express a wider range of high order information, essentially conveying the concept of Readiness. This does not preclude a cBeX from throwing events in other categories (such as internal transactions or network operations).

What Does the UDM Measure? The Uniform Data Model provides a uniform measure of operability across all Behavior Experts for all components, processes, and models. By “operability” we mean the quality of operation as expressed by a set of rules in the BeX. These rules connect physical operations with expert knowledge to yield a ranking of the operation in one or more measures. It is this qualitative measure that allows the entire BeX framework to work laterally and vertically. By connecting through the UDM to children BeX modules, an integrator BeX (as an example) can apply performance analysis metrics across all its lower level BeX's without having expert knowledge about the meaning of quantitative (numerical, ordinal, interval) values associated with a particular component, process, or service.

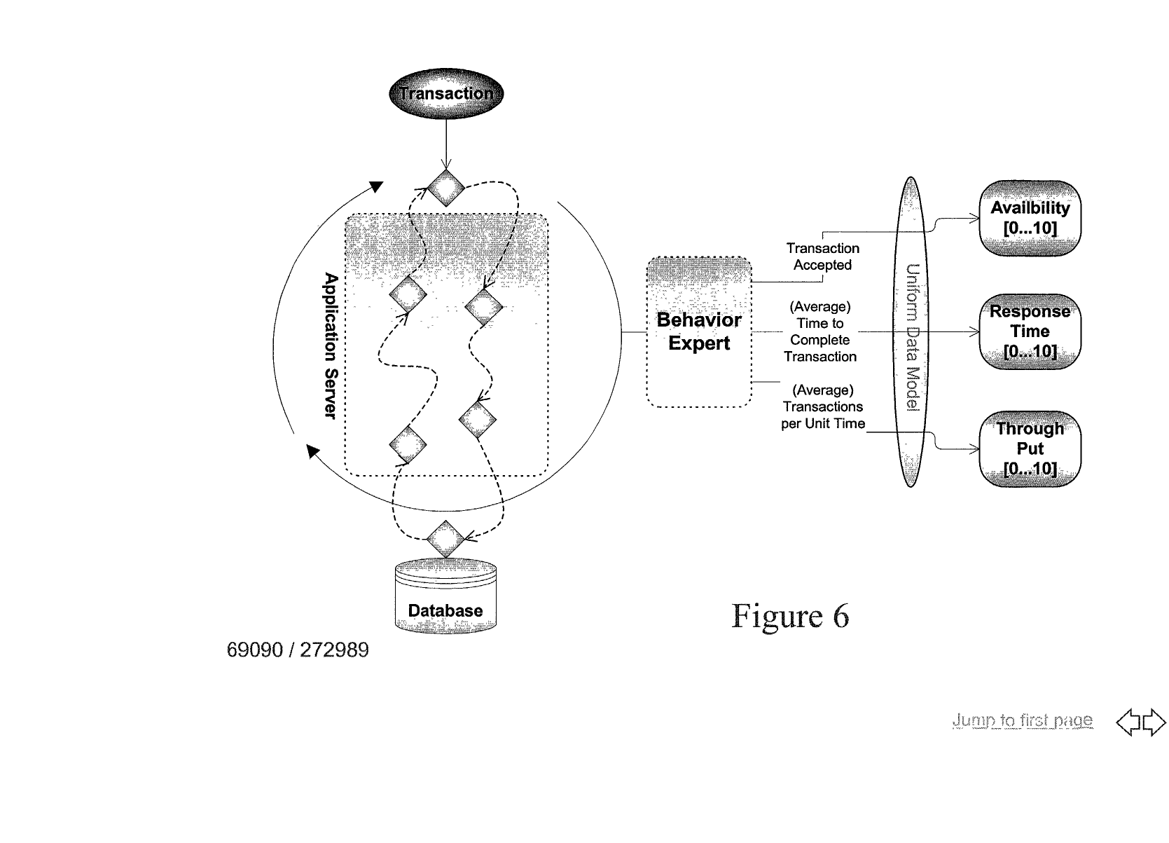

As we can see in FIG. 6, a BeX can expertly analyze the performance of a component using heuristic, mathematical, and statistical techniques to generate parametric results that are, in the final analysis, quantitative. The BeX must also apply a knowledge perspective and categorize these “hard” values into a qualitative assessment of each measure. FIG. 6 illustrates the quantitative and qualitative UDM. How a BeX communicates quantitative and qualitative information through the Uniform Data Model is based on the understanding of both the characteristics and properties of system events as well as the process flow of events through the system. It is, of course, the event interface that actually implements the UDM protocol (although the structural organization of events in the system can be different).

The UDM Event Organization and Mechanisms

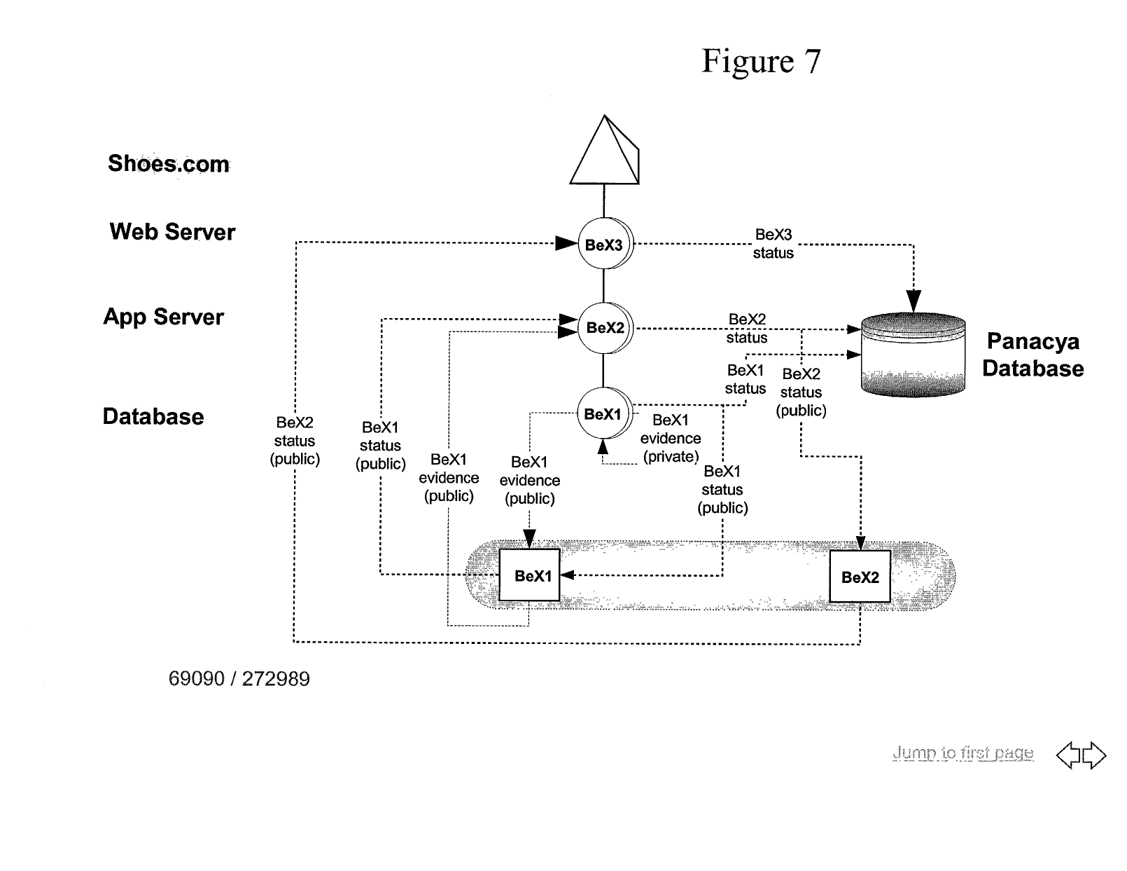

There are two families of events thrown by a BeX—Evidence and Status. An evidence event is (usually, but not always) local to the machine and is sharable through the blackboard server. Status Events are also shared through the blackboard, but are sent, via the communication interface, a global data repository where they are used by the eService manager to alter the state of visualization elements in the model display. FIG. 7 illustrates schematically how these events flow through a relatively simple eService management environment for a shoe.com service.

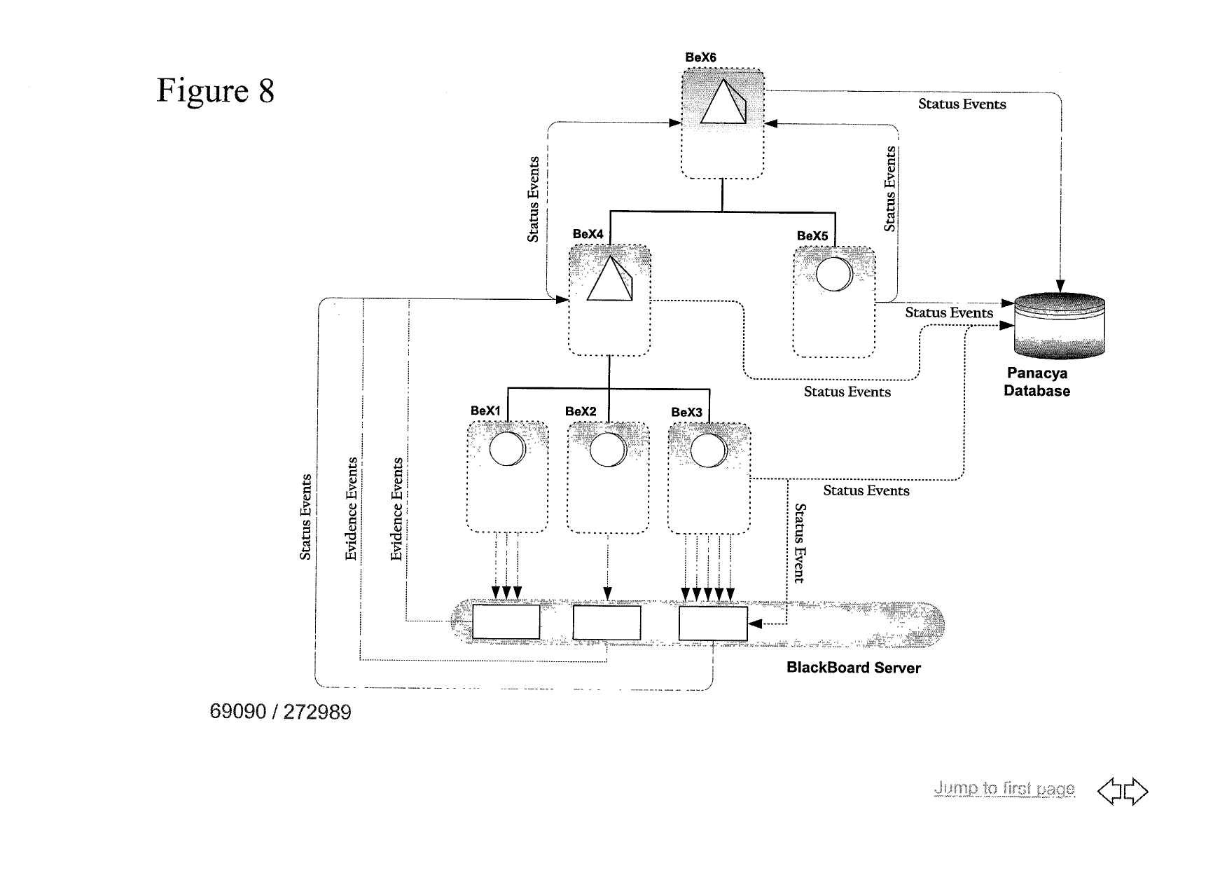

FIG. 7 shows event flow through the eService System. As this figure shows there are two reservoirs of events: the system blackboard and the central repository. The blackboard server keeps events at the machine level and provides a sharing mechanism for all the BeX's attached to the blackboard (the blackboard also supports the sharing of events in a distributed environment). The database stores primarily status events—the state of a component as computed by the Behavior Expert—and is the foundation for all icon management in the eService manager's model display. The interchange of events, both vertically and laterally (that is, from the database or form the blackboard) is the core method of communicating between BeXs. FIG. 8 shows how these event types are exchanged through a slightly more complex topology.

FIG. 8. shows the flow of events in the topology. It is the interchange of events throughout a complex and changing topology that dictates the imposition of a Uniform Data Model. Only the standardization of the data interfaces permits us to build and deploy these kinds of connected architectures in a more or less “plug and play” way.

Evidence Events

Evidence events are thrown by a rule indicating that some state has changed within the BeX logic. These evidence events can be read by a parent BeX to make decisions about the state of the child BeX.

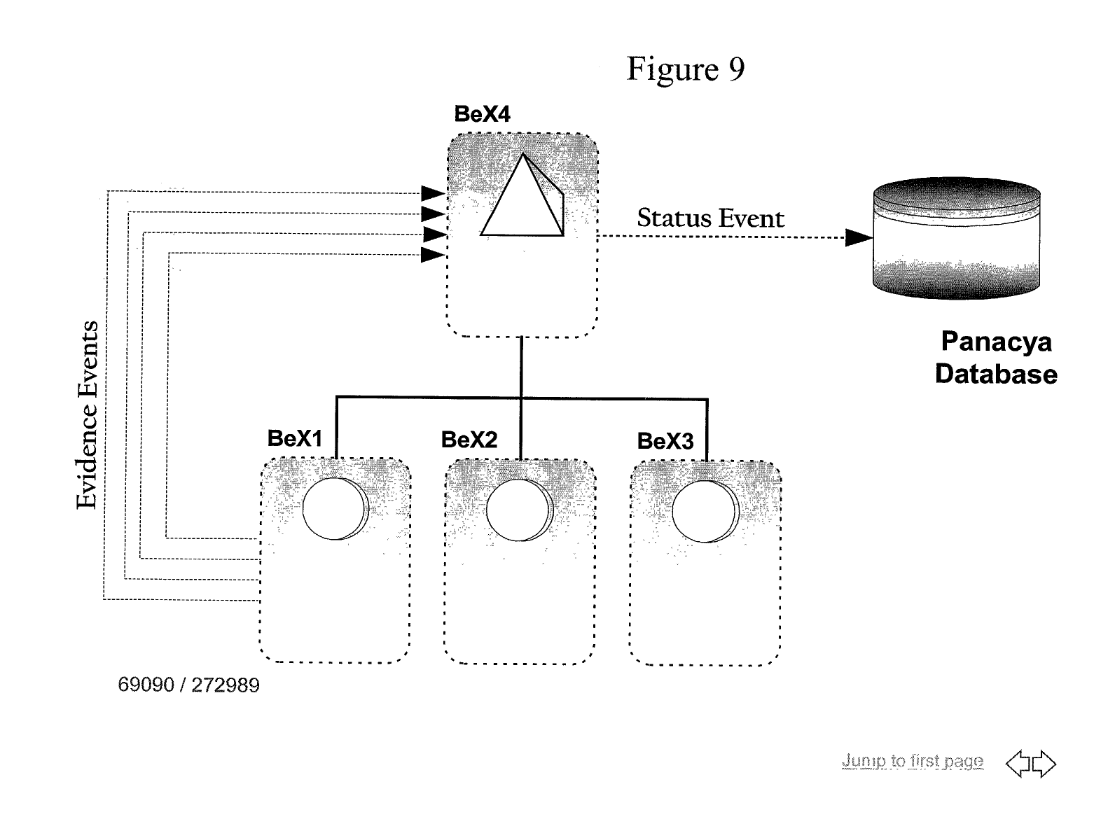

FIG. 9 shows the relationships among evidence events, status events and BeXs. Evidence events have no impact on the eService manager's display. Public Evidence events are stored on the system blackboard and can be read (as ordinary data input streams) by other BeXs (usually, but not necessarily, to the BeX's topological parent). Private evidence events are accessible only to the BeX that threw the event (this means that a BeX can read its own events).

What is claimed is:

1. A method for constructing a uniform event representation for an event in accordance with a uniform data model, said method comprising:
selecting a category, to which said event belongs, said category being selected from a plurality of categories defined by said uniform data model;
selecting at least one measurement type, based on which the event is triggered, said at least one measurement being selected from a plurality of measurement types defined by said uniform data model;
incorporating quantitative values of said at least one measurement type into said uniform event representation, said quantitative values being acquired by a process in which said event is detected; and
incorporating qualitative assessment for each of said at least one measurement into said uniform event representation, said qualitative assessment being generated by said process.

2. The method according to claim 1, further comprising:
generating an event ID for said event to be incorporated in said uniform event representation;
incoporating the ID of said process, where said event is detected, in said uniform event representation;
incorporating at least one piece of evidence, based on which said event is detected, in said uniform event representation; and
incorporating a description about said event in said uniform event representation.

3. The method according to claim 1, wherein said categories include meta-category, external transaction category, internal category, operating system category, application category, and network category.

4. The method according to claim 1, wherein said measurement types include availability, response time, throughput, and service readiness.

5. A method of using a uniform data model, said method comprising:
posting zero or more events, described in uniform event representation constructed based on uniform data model, in an event pool by a process where said zero or more events are generated; and
accessing an event, described in uniform event representation constructed based on uniform data model and posted in said event pool, by a process.

6. The method according to claim 6, wherein said event pool includes a blackboard server.

7. A method for using a uniform data model, said method comprising:
generating a uniform event representation for an event by a process where said event is detected, said uniform event representation being constructed in accordance with said uniform data model; and
sending said uniform event representation for said event, by said process, to a different process to notify said different process about the occurrence of said event.

8. The method according to claim 7, further comprising:
receiving, by a process, a uniform event representation, constructed in accordance with said uniform data model, from a different process, said uniform event representation describing an event occurred and detected by said different process.

9. The method according to claim 1, wherein said process includes a behavior expert.

10. The method according to claim 7, wherein said process includes a behavior expert.

11. The method according to claim 8, wherein said process includes a behavior expert.
